(19) United States
(12) Patent Application Publication
(10) Pub. No.: US 2024/0026101 A1
(43) Pub. Date: Jan. 25, 2024

(54) BIODEGRADABLE HIGH-BARRIER PACKAGING FILM AND PREPARATION METHOD AND APPLICATION THEREOF

(71) Applicant: Beijing Technology and Business University, Beijing (CN)

(72) Inventors: Caili ZHANG, Beijing (CN); Yunxuan WENG, Beijing (CN); Fan YANG, Beijing (CN); Xinyu SONG, Beijing (CN); Yang YANG, Beijing (CN)

(21) Appl. No.: 18/318,074

(22) Filed: May 16, 2023

(30) Foreign Application Priority Data
Jul. 20, 2022 (CN) 202210863595.8

(51) Int. Cl. C08J 5/18; B29C 48/08; B29C 48/00

(52) U.S. Cl. CPC C08J 5/18; B29C 48/08; B29C 48/022; C08J 2367/04; C08J 2367/02; B29K 2067/043

(57) ABSTRACT

Disclosed are a biodegradable high-barrier packaging film, a preparation method and an application thereof, belonging to the technical field of biodegradable packaging film processing. The biodegradable high-barrier packaging film includes 60-70 parts of polyglycolic acid (PGA), 40-30 parts of poly(butylene succinate-co-butylene adipate) (PBSA), and 0.1-0.7 part of ADR 4468 (copolymer of styrene, acrylate and glycidyl acrylate), where a sum of the PGA and the PBSA is 100 parts. The preparation method of the biodegradable high-barrier packaging film includes: mixing the PGA, the PBSA and ADR 4468 (copolymer of styrene, acrylate and glycidyl acrylate), and performing melting, extruding and granulating to obtain a blends masterbatch; then extrusion blowing the blends masterbatch into a film to obtain the biodegradable high-barrier packaging film.

### CROSS-REFERENCE TO RELATED APPLICATIONS

This application claims priority to Chinese Patent Application No. 202210863595.8, filed on Jul. 20, 2022, the contents of which are hereby incorporated by reference.

### TECHNICAL FIELD

The present application belongs to the technical field of biodegradable food film processing, and in particular to a biodegradable high-barrier packaging film, a preparation method and an application thereof.

### BACKGROUND

Polyglycolic acid (PGA) is a green material that decomposes in the environment to glycolic acid, a natural metabolite that is directly absorbed by the cells of mammals. PGA has good mechanical strength and barrier properties, with an oxygen barrier performance of 1,000 times that of polylactic acid (PLA) and 100 times that of polyethylene terephthalate (PET). Though the gas barrier properties of PGA are excellent, the inherent brittleness and poor strength of the PGA melt severely limit the processing and application of PGA. The relatively small difference between the melting temperature Tm (220 degrees Celsius, ° C.) and the crystallization temperature (Tc=192-198° C.) of PGA makes it especially difficult to prepare homogenous and transparent films as the melt crystallizes rapidly once it is cooled during the extrusion of samples such as films and sheets; moreover, the difference of glass transition temperature Tg (40-45° C.) and cold crystallization temperature (Tcc=75° C.) of PGA is also relatively small, which causes great difficulties for extrusion blowing of PGA into films; besides, the difference of glass transition temperature Tg (40-45° C.) and cold crystallization temperature (Tcc=75° C.) of PGA is also relatively small, which causes great difficulties for extrusion blowing of PGA into films. In addition, PGA has poor thermal stability and undergoes thermal decomposition in the molten state to produce products of low molecular weight, resulting in the generation of gas during melting processing.

It is a common practice to add the flexible biodegradable polyester polybutylene adipate terephthalate (PBAT) to PGA to improve the toughness of the material. However, the non-renewable nature of the terephthalic acid monomer contained in the PBAT structure, which is derived from petroleum sources, and the slow biodegradation in the environment due to the benzene ring structure of PBAT, make it unfavorable for short-cycle plastic packaging films. It is generally expected that packaging films biodegrade quickly after disposal, thus alleviating the problem of plastic pollution. poly(butylene succinate-co-butylene adipate) (PBSA) is a class of aliphatic polyesters with a flexible molecular chain structure and the advantages of low cost, good mechanical properties (between polyethylene and polypropylene) and excellent processability, and the elongation at break of PBSA is comparable to that of PBAT (about 700%); in comparison with the petroleum-based degradable plastic PBAT, the monomers for synthesizing PBSA can all be obtained from renewable resources through microbial fermentation, and PBSA biodegrades faster than PBAT, thus being conducive to the environment protection. Therefore, a ductile PGA/PBSA composite material is expected by utilizing the good elasticity and elongation at break of PBSA, as well as the good film formation properties. Despite the significant superiority of PGA/PBSA composites in developing biodegradable films with good toughness, the barrier properties of PGA deteriorate when PBSA is added to PGA, as a result of the high permeability of PGA against oxygen and water vapor. Therefore, it is of importance to develop a simple and efficient preparation method to prepare PGA-based composite films with properties of high toughness and high barrier.

### SUMMARY

In view of solving the above problems in the prior art, the present application provides a biodegradable high-barrier packaging film, a preparation method and an application thereof.

In order to achieve the above objectives, the present application provides the following technical schemes:
one of the technical schemes of the present application provides a biodegradable high-barrier packaging film, including raw materials in parts by weight as follows: 60-70 parts of polyglycolic acid (PGA), 30-40 parts of poly(butylene succinate-co-butylene adipate) (PBSA) and 0-0.7 part of ADR 4468, where a sum of the PGA and the PBSA is 100 parts.

Optionally, the biodegradable high-barrier packaging film includes the following raw materials in parts by weight: 70 parts of PGA, 30 parts of PBSA and 0.5 part of ADR 4468.

Another technical scheme of the present application provides a preparation method of the biodegradable high-barrier packaging film, including steps as follows: mixing PGA, PBSA and ADR 4468, and performing melting, extruding and granulating to obtain a blends masterbatch; then extrusion blowing the blends masterbatch into a film to obtain the biodegradable high-barrier packaging film.

Optionally, the melting, extruding and granulating are carried out under temperature of 180-230 degrees Celsius (° C.).

Optionally, a temperature of extrusion blowing into the film is 215-220° C., and a take-up speed is 0.5-2.5 meters per minute (m/min).

Optionally, the take-up speed is 1.5 m/min.

Another technical scheme of the present application provides an application of the biodegradable high-barrier packaging film as food packaging materials.

Optionally, the food packaging is the vacuum packaging of meat and snacks.

The present application achieves the following beneficial effects as comparing to the prior art:
the present application solves the problem of poor toughness of PGA and its inability to be blown into a film by adding a flexible biodegradable polyester PBSA to PGA, and enhances the interfacial adhesion of the two phases by adding an appropriate amount of ADR 4468 chain extender to the PGA/PBSA composite, thus improving the mechanical properties and barrier property against oxygen and water vapor of PGA/PBSA; and
the flexible PBSA forms microfibers in situ under the action of directional stretching with suitable external traction during the extrusion blowing process of the present application, thereby toughening the PGA; under the synergy of the stretching flow field and the microfibers as heterogeneous nucleation sites, the movement of the PGA molecular chains is effectively promoted to form a directionally aligned crystalline structure; consequently, the barrier and mechanical properties of the composite film are significantly improved with the aid of a large number of oriented PGA wafers and flexible polyesters of micro/nanofiber size.

### BRIEF DESCRIPTION OF THE DRAWINGS

For a clearer illustration of the technical schemes in the embodiments of the present application or in the prior art, a brief description of the accompanying drawings to be used in the embodiments is given below. It is obvious that the accompanying drawings in the following description are only some embodiments of the present application and that other accompanying drawings are available to those of ordinary skill in the art without any creative effort.

FIG. 1A shows a cross-sectional scanning electron microscope (SEM) image of a packaging film prepared in Embodiment 3.

FIG. 1B shows a cross-sectional SEM image of a packaging film prepared in Embodiment 8.

FIG. 1C shows a cross-sectional SEM image of a packaging film prepared in Comparative embodiment 3.

FIG. 2 is an X-ray diffraction pattern of the packaging films prepared in Embodiment 3 and Embodiment 8.

FIG. 3 shows a combined comparison of the packaging film of Embodiment 3 and currently commercially available packaging films in terms of barrier properties, tensile strength and elongation at break.

### DETAILED DESCRIPTION OF THE EMBODIMENTS

Various exemplary embodiments of the present application are now described in detail and this detailed description should not be considered as limiting the present application, but should be understood as a more detailed description of certain aspects, features and embodiments of the present application. It should be understood that the terms described in the present application are intended to describe particular embodiments only and are not intended to limit the present application.

Furthermore, with respect to the range of values in the present application, it is to be understood that each intermediate value between the upper and lower limits of the range is also specifically disclosed. Each smaller range between any stated value or intermediate value within a stated range and any other stated value or intermediate value within a stated range is also included in the present application. The upper and lower limits of these smaller ranges may be independently included or excluded from the scope.

Unless otherwise stated, all technical and scientific terms used herein have the same meaning as is commonly understood by those of ordinary skill in the field described in the present application. Although the present application describes only preferred methods and materials, any methods and materials similar or equivalent to those described herein may also be used in the implementation or testing of the present application. All literature referred to in this specification is incorporated by reference for the purpose of disclosing and describing the methods and/or materials associated with said literature. In the event of conflict with any incorporated literature, the contents of this specification shall prevail.

Without departing from the scope or spirit of the present application, various improvements and variations may be made to specific embodiments of the specification of the present application, as will be apparent to those skilled in the art. Other embodiments obtained from the specification of the present application will be obvious to the skilled person. The specification and embodiments of the present application are only exemplary.

As used herein, the words “comprising”, “including”, “having”, “containing”, etc., are open-ended terms, i.e. meaning including but not limited to.

The present application provides a biodegradable high-barrier packaging film, including the following raw materials in parts by weight: 60-70 parts of polyglycolic acid (PGA), 30-40 parts of poly(butylene succinate-co-butylene adipate) (PBSA) and 0-0.7 part of ADR 4468, where a sum of the PGA and the PBSA is 100 parts.

A preparation method of the biodegradable high-barrier packaging film of the present application includes the following steps: firstly, mixing PGA, PBSA and ADR 4468, and performing melting, extruding and granulating to obtain a blends masterbatch; then extrusion blowing the blends masterbatch into a film to obtain the biodegradable high-barrier packaging film.

Optionally, the melting, extruding and granulating are carried out under temperature of 180-230 degrees Celsius (° C.).

A twin-screw extruder is used in the following embodiments for melting, extruding and granulating, and a single-screw extruder or kneader is optional depending on the actual needs.

Optionally, a temperature of extrusion blowing into the film is 215-220° C., and a take-up speed is 0.5-2.5 meters per minute (m/min).

In the following embodiments, PGA is purchased from Shanghai Pujing Chemical Industry Co., Ltd., PBSA is purchased from Showa Denko, Japan, and ADR is purchased from BASF Corporation (model number of ADR 4468).

### Embodiment 1

Preparation of a Biodegradable High-Barrier Packaging Film 70PGA-1.5

7 kilograms (kg) PGA and 3 kg PBSA are mixed and subjected to melting extrusion and granulation with a twin-screw extruder to obtain a blends masterbatch, where the extruder is arranged with a five-section temperatures of 180° C., 190° C., 210° C., 220° C. and 230° C. in turn from a first zone to a die zone; then the blends masterbatch is blow-molded into a film using a extrusion blowing machine to obtain a biodegradable high-barrier packaging film, where the temperatures from the first zone to the die zone during the extrusion blowing are set as 215° C., 220° C. and 220° C. in turn, and a take-up speed is 1.5 m/min; the obtained biodegradable high-barrier packaging film is recorded as 70PGA-1.5.

### Embodiment 2

Preparation of a Biodegradable High-Barrier Packaging Film 70PGA/0.3ADR-1.5

7 kg PGA and 3 kg PBSA and 0.03 kg ADR 4468 are mixed and subjected to melting extrusion and granulation with a twin-screw extruder to obtain a blends masterbatch, where the extruder is arranged with a five-section temperatures of 180° C., 190° C., 210° C., 220° C. and 230° C. in turn from a first zone to a die zone; then the blends masterbatch is blow-molded into a film using a extrusion blowing machine to obtain a biodegradable high-barrier packaging film, where the temperatures from the first zone to the die zone during the extrusion blowing are set as 215° C., 220° C. and 220° C. in turn, and a take-up speed is 1.5 m/min; the obtained biodegradable high-barrier packaging film is recorded as 70PGA/0.3ADR-1.5.

### Embodiment 3

Preparation of a Biodegradable High-Barrier Packaging Film 70PGA/0.5ADR-1.5

7 kg of PGA, 3 kg of PBSA and 0.05 kg ADR 4468 are mixed and subjected to melting extrusion and granulation with a twin-screw extruder to obtain a blends masterbatch, where the extruder is arranged with a five-section temperatures of 180° C., 190° C., 210° C., 220° C. and 230° C. in turn from a first zone to a die zone; then the blends masterbatch is blow-molded into a film using a extrusion blowing machine to obtain a biodegradable high-barrier packaging film, where the temperatures from the first zone to the die zone during the extrusion blowing are set as 215° C., 220° C. and 220° C. in turn, and a take-up speed is 1.5 m/min; the obtained biodegradable high-barrier packaging film is recorded as 70PGA/0.5ADR-1.5.

### Embodiment 4

Preparation of a Biodegradable High-Barrier Packaging Film 70PGA/0.7ADR-1.5

7 kg of PGA, 3 kg of PBSA and 0.07 kg ADR 4468 are mixed and subjected to melting extrusion and granulation with a twin-screw extruder to obtain a blends masterbatch, where the extruder is arranged with a five-section temperatures of 180° C., 190° C., 210° C., 220° C. and 230° C. in turn from a first zone to a die zone; then the blends masterbatch is blow-molded into a film using a extrusion blowing machine to obtain a biodegradable high-barrier packaging film, where the temperatures from the first zone to the die zone during the extrusion blowing are set as 215° C., 220° C. and 220° C. in turn, and a take-up speed is 1.5 m/min; the obtained biodegradable high-barrier packaging film is recorded as 70PGA/0.7ADR-1.5.

### Embodiment 5

Preparation of a Biodegradable High-Barrier Packaging Film 60PGA-1.5

6 kg PGA and 4 kg PBSA are mixed and subjected to melting extrusion and granulation with a twin-screw extruder to obtain a blends masterbatch, where the extruder is arranged with a five-section temperatures of 180° C., 190° C., 210° C., 220° C. and 230° C. in turn from a first zone to a die zone; then the blends masterbatch is blow-molded into a film using a extrusion blowing machine to obtain a biodegradable high-barrier packaging film, where the temperatures from the first zone to the die zone during the extrusion blowing are set as 215° C., 220° C. and 220° C. in turn, and a take-up speed is 1.5 m/min; the obtained biodegradable high-barrier packaging film is recorded as 60PGA-1.5.

### Embodiment 6

Preparation of a Biodegradable High-Barrier Packaging Film 60PGA/0.5ADR-1.5

6 kg of PGA, 4 kg of PBSA and 0.05 kg ADR 4468 are mixed and subjected to melting extrusion and granulation with a twin-screw extruder to obtain a blends masterbatch, where the extruder is arranged with a five-section temperatures of 180° C., 190° C., 210° C., 220° C. and 230° C. in turn from a first zone to a die zone; then the blends masterbatch is blow-molded into a film using a extrusion blowing machine to obtain a biodegradable high-barrier packaging film, where the temperatures from the first zone to the die zone during the extrusion blowing are set as 215° C., 220° C. and 220° C. in turn, and a take-up speed is 1.5 m/min; the obtained biodegradable high-barrier packaging film is recorded as 60PGA/0.5ADR-1.5.

### Embodiment 7

Preparation of a Biodegradable High-Barrier Packaging Film 70PGA/0.5ADR-2.5

7 kg of PGA, 3 kg of PBSA and 0.05 kg ADR 4468 are mixed and subjected to melting extrusion and granulation with a twin-screw extruder to obtain a blends masterbatch, where the extruder is arranged with a five-section temperatures of 180° C., 190° C., 210° C., 220° C. and 230° C. in turn from a first zone to a die zone; then the blends masterbatch is blow-molded into a film using a extrusion blowing machine to obtain a biodegradable high-barrier packaging film, where the temperatures from the first zone to the die zone during the extrusion blowing are set as 215° C., 220° C. and 220° C. in turn, and a take-up speed is 2.5 m/min; the obtained biodegradable high-barrier packaging film is recorded as 70PGA/0.5ADR-2.5.

In the present embodiment, the increased take-up speed does not allow for the continuous production of uniform thickness, non-porous films, and the prepared composite films have many defects.

### Embodiment 8

Preparation of a Biodegradable High-Barrier Packaging Film 70PGA/0.5ADR-0.5

7 kg of PGA, 3 kg of PBSA and 0.05 kg ADR 4468 are mixed and subjected to melting extrusion and granulation with a twin-screw extruder to obtain a blends masterbatch, where the extruder is arranged with a five-section temperatures of 180° C., 190° C., 210° C., 220° C. and 230° C. in turn from a first zone to a die zone; then the blends masterbatch is blow-molded into a film using a extrusion blowing machine to obtain a biodegradable high-barrier packaging film, where the temperatures from the first zone to the die zone during the extrusion blowing are set as 215° C., 220° C. and 220° C. in turn, and a take-up speed is 0.5 m/min; and the obtained biodegradable high-barrier packaging film is recorded as 70PGA/0.5ADR-0.5.

### Comparative Embodiment 1

Preparation of a PBSA Packaging Film

10 kg of PBSA is subjected to melting extrusion and granulation with a twin-screw extruder to obtain a blends masterbatch, where the extruder is arranged with a five-section temperatures of 180° C., 190° C., 210° C., 220° C. and 230° C. in turn from a first zone to a die zone; then the blends masterbatch is blow-molded into a film using a extrusion blowing machine to obtain a packaging film, where the temperatures from the first zone to the die zone during the extrusion blowing are set as 215° C., 220° C. and 220° C. in turn, and a take-up speed is 1.5 m/min; and the obtained packaging film is recorded as PBSA.

### Comparative Embodiment 2

Preparation of a P-70PGA Packaging Film

7 kg PGA and 3 kg PBSA are mixed and subjected to melting extrusion and granulation with a twin-screw extruder to obtain a blends masterbatch, where the extruder is arranged with a five-section temperatures of 180° C., 190° C., 210° C., 220° C. and 230° C. in turn from a first zone to a die zone; the blends masterbatch is then press-molded using a press-moulding machine to obtain a packaging film, where the temperature during the press-moulding is set as 215° C.-220° C.; the obtained packaging film is recorded as P-70PGA.

### Comparative Embodiment 3

Preparation of a Packaging Film P-70PGA/0.5ADR

7 kg of PGA, 3 kg of PBSA and 0.05 kg ADR 4468 are mixed and subjected to melting extrusion and granulation with a twin-screw extruder to obtain a blends masterbatch, where the extruder is arranged with a five-section temperatures of 180° C., 190° C., 210° C., 220° C. and 230° C. in turn from a first zone to a die zone; the blends masterbatch is then press-molded using a press-moulding machine to obtain a packaging film, where the temperature during the press-moulding is set as 215° C.-220° C.; the obtained packaging film is recorded as 70PGA/0.5ADR.

### Comparative Embodiment 4

Same as Embodiment 3, except that 7 kg of PGA, 3 kg of PBAT and 0.05 kg ADR 4468 are mixed.

### Comparative Embodiment 5

Same as Embodiment 3, except that 8.5 kg of PGA, 1.47 kg PBSA and 0.03 kg ADR 4468 are mixed.

With a PGA content of 85 parts, the resulting film material obtains a high degree of hardness and brittleness and therefore cannot be used as packaging film.

### Comparative Embodiment 6

Same as Embodiment 3, except that the temperatures are set as 150° C., 160° C. and 170° C. in turn from the first zone to the die zone during the extrusion blowing.

It is observed from the present comparative embodiment that the extrusion blowing fails when the extrusion blowing machine is not set with temperatures of 215-220° C. from the first zone to the die zone.

### Comparative Embodiment 7

Same as Embodiment 3, except that the temperatures are set as 205° C., 210° C. and 210° C. in turn from the first zone to the die zone during the extrusion blowing.

In the present comparative embodiment, the films formed by extrusion blowing are incomplete and defective, suggesting that the film cannot be formed if the temperature of the extrusion blowing is not in the range of 215-220° C.

Performance Verification

In accordance with GB/T 10004-2008 and GB/T 16578.1-2008, the biodegradable high-barrier packaging films prepared in Embodiments 1-8 and the packaging films prepared in Comparative embodiments 1-5 are tested for tensile and tear properties respectively, and the test results are shown in Table 1.

TABLE 1
Comparison of mechanical properties of the films

| | Tensile strength (MPa) | | | | | | | |
|---|---|---|---|---|---|---|---|---|
| | Machine | Traverse | | | | | | |
| | direction | direction | Elongation at break (%) | | Young's modulus (MPa) | | Tearing strength (KN/m) | |
| | (MD) | (TD) | MD | TD | MD | TD | MD | TD |
| Embodiment 1 | 39.36 ± | 34.30 ± | 521.58 ± | 456.94 ± | 1001.41 ± | 751.24 ± | 153.87 ± | 126.22 ± |
| | 3.25 | 6.72 | 53.57 | 10.94 | 162.42 | 212.34 | 20.96 | 2.52 |
| Embodiment 2 | 51.37 ± | 36.55 ± | 414.58 ± | 183.45 ± | 1643.64 ± | 1030.45 ± | 227.00 ± | 138.05 ± |
| | 5.05 | 5.34 | 31.11 | 55.24 | 324.36 | 190.23 | 43.93 | 26.48 |
| Embodiment 3 | 52.08 ± | 32.42 ± | 604.44 ± | 392.67 ± | 1105.59 ± | 1200.83 ± | 259.24 ± | 127.34 ± |
| | 4.80 | 2.40 | 37.28 | 72.83 | 257.30 | 181.15 | 18.40 | 11.66 |
| Embodiment 4 | 47.37 ± | 25.67 ± | 505.55 ± | 268.12 ± | 760.96 ± | 1027.77 ± | 160.36 ± | 107.40 ± |
| | 6.15 | 3.59 | 44.27 | 87.33 | 169.08 | 251.71 | 8.89 | 12.01 |
| Embodiment 5 | 43.56 ± | 16.21 ± | 202.21 ± | 96.12 ± | 275.87 ± | 554.34 ± | 174.48 ± | 86.30 ± |
| | 2.30 | 1.29 | 46.05 | 0.38 | 87.30 | 158.50 | 0.48 | 10.20 |
| Embodiment 6 | 34.54 ± | 17.65 ± | 272.94 ± | 107.70 ± | 933.30 ± | 698.61 ± | 191.43 ± | 90.74 ± |
| | 0.28 | 2.08 | 29.39 | 2.37 | 91.88 | 69.38 | 27.33 | 6.32 |
| Embodiment 7 | / | / | / | / | / | / | / | / |
| Embodiment 8 | 45.65 ± | 19.82 ± | 148.79 ± | 12.04 ± | 1194.63 ± | 770.82 ± | 209.19 ± | 111.98 ± |
| | 1.29 | 2.58 | 51.28 | 1.79 | 266.24 | 206.63 | 9.24 | 20.06 |
| Comparative | 25.20 ± | 24.88 ± | 887.59 ± | 770.76 ± | 68.98 ± | 66.00 ± | 99.31 ± | 126.034 ± |
| embodiment 1 | 1.33 | 0.19 | 30.94 | 13.28 | 2.44 | 1.56 | 3.27 | 5.31 |
| Comparative | 64.27 ± | | 11.02 ± | | 439.94 ± | | / | / |
| embodiment 2 | 1.52 | | 1.53 | | 11.83 | | | |
| Comparative | 42.85 ± | | 8.40 ± | | 377.13 ± | | / | / |
| embodiment 3 | 4.93 | | 1.73 | | 91.12 | | | |
| Comparative | 47.76 ± | 31.43 ± | 71.81 ± | 35.38 ± | 1597.00 ± | 529.85 ± | 47.76 ± | 31.43 ± |
| embodiment 4 | 0.78 | 0.69 | 4.71 | 0.91 | 81.90 | 11.67 | 0.78 | 0.69 |
| Comparative | / | / | / | / | / | / | / | / |
| embodiment 5 | | | | | | | | |
| Comparative | / | / | / | / | / | / | / | / |
| embodiment 6 | | | | | | | | |
| Comparative | / | / | / | / | / | / | / | / |
| embodiment 7 | | | | | | | | |

The O₂ permeability coefficient and permeability rate of the packaging films prepared in Embodiments 1-8 and Comparative embodiments 1-5 are measured by a VAC-V2 differential pressure gas permeation meter at 23° C. and 30% relative humidity according to ASTM D3985, and the water vapor permeability coefficient and permeability rate of the packaging films prepared from Embodiments 1-8 and Comparative embodiments 1-5 are measured by a C360M weight loss method at 38° C. and 90% relative humidity according to GB/T 1037, see Table 2 for the test results.

TABLE 2
Comparison of barrier properties against oxygen and water vapor

| | Oxygen | O₂ | Water | Water vapor |
|---|---|---|---|---|
| | trans- | perme- | vapor trans- | permeability, |
| | mission | ability | mission | WVP |
| | rate, OTR | (10⁻⁴ | rate, WVTR | (10⁻¹⁴ g · cm/ |
| | (cm³/m² · 24 h) | Barrer*) | g/(m² · day) | cm² · s · Pa) |
| Embodiment 1 | 0.65 | 4.21 | 23.06 | 1.45 |
| Embodiment 2 | 0.63 | 3.29 | 21.70 | 1.28 |
| Embodiment 3 | 0.56 | 2.93 | 21.25 | 1.20 |
| Embodiment 4 | 0.56 | 2.34 | 21.15 | 1.15 |
| Embodiment 5 | 13.78 | 102.8 | 51.60 | 8.00 |
| Embodiment 6 | 16.73 | 124.1 | 48.29 | 6.89 |
| Embodiment 7 | / | / | / | / |
| Embodiment 8 | 9.97 | 134.8 | 14.98 | 1.76 |
| Comparative | / | / | 468.57 | 33.4 |
| embodiment 1 | | | | |
| Comparative | 19.92 | 427.8 | 10.09 | 2.21 |
| embodiment 2 | | | | |
| Comparative | 11.35 | 139.4 | 14.84 | 2.19 |
| embodiment 3 | | | | |
| Comparative | 22.52 | 160 | 27.83 | 2.39 |
| embodiment 4 | | | | |
| Comparative | / | / | / | / |
| embodiment 5 | | | | |
| Comparative | / | / | / | / |
| embodiment 6 | | | | |
| Comparative | / | / | / | / |
| embodiment 7 | | | | |

1 Barrer = 10⁻¹⁰ cm³ · cm/cm² · s · cm Hg.

It can be seen from Table 1 and Table 2 that the packaging film 70PGA/0.5ADR-1.5 prepared in Embodiment 3 of the present application has the best processability, mechanical properties and barrier properties.

Comparing with Embodiment 2, the mechanical properties of the composite film are reduced and the barrier properties against oxygen and water vapor are reduced as the content of ADR is reduced from 0.5 parts to 0.3 parts in the Embodiment 3, indicating that ADR can effectively enhance the interfacial adhesion between the two phases of PGA and PBSA and reduce the interfacial tension, thus effectively improving the mechanical properties and barrier properties of the composite film. As comparing to the Embodiment 4, the mechanical properties of the composite film prepared in Embodiment 3 shows a decrease with the increase of the ADR content from 0.5 to 0.7 part, and the barrier properties against oxygen and water vapor are similar. The reason for this is that although the chain extender ADR can effectively enhance the interfacial adhesion between the two phases of PGA and PBSA and reduce the interfacial tension, thus effectively improving the mechanical properties and barrier properties of the composite film, excessive addition of ADR, which has not reacted with PGA and PBSA to extend the chain, will cause micro-phase separation, resulting in a reduction in the mechanical properties of the composite film, and therefore the optimum amount of ADR to be added is 0.5 part.

The take-up speed is increased from 1.5 m/min to 2.5 m/min in Embodiment 7 in comparison to Embodiment 3, where the continuous production of the composite film fails due to the low melt strength of the PGA itself and the melt breakage caused by too fast a take-up speed. In the Embodiment 8, the take-up speed is reduced from 1.5 m/min of Embodiment 3 to 0.5 m/min, and the obtained composite film shows obvious reduction of mechanical strength and barrier properties, mainly owing to the low take-up speed of the external tensile flow field, which prevents the PBSA from being produced in situ in a continuous fibrous form, but is instead dispersed in the PGA in a granular form. Continuous fibrous PBSA improves the mechanical and barrier properties of the composite film by extending the diffusion path of gas molecules compared to granular PBSA.

As can be seen from Tables 1 and 2, the gas barrier properties of the films of both Embodiment 8 and Comparative embodiment 3 are similar, mainly because both Comparative embodiment 3, which is formed by press-molding, and Embodiment 8, which is formed by extrusion blowing into films with low stretching rates, are short of appropriate external traction, resulting in the PBSA not being dispersed in fibrous form but in granular form, thus making both the mechanical and barrier properties inferior.

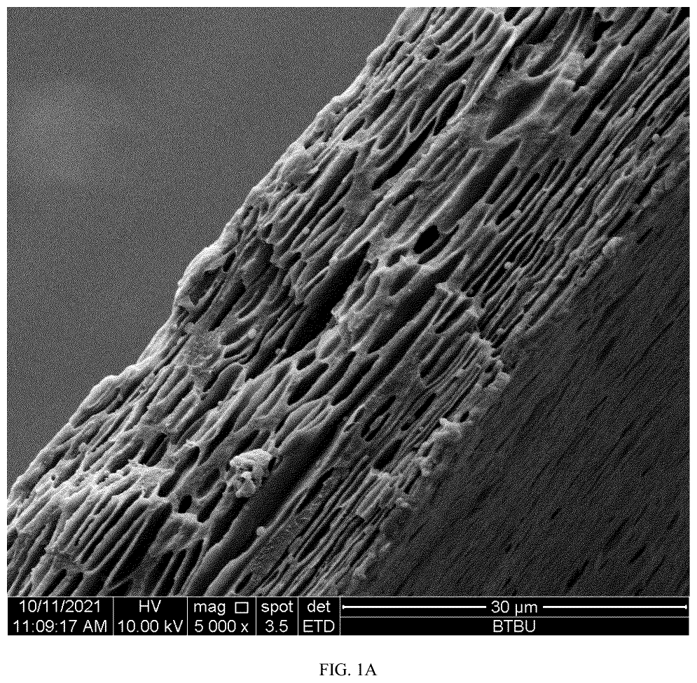

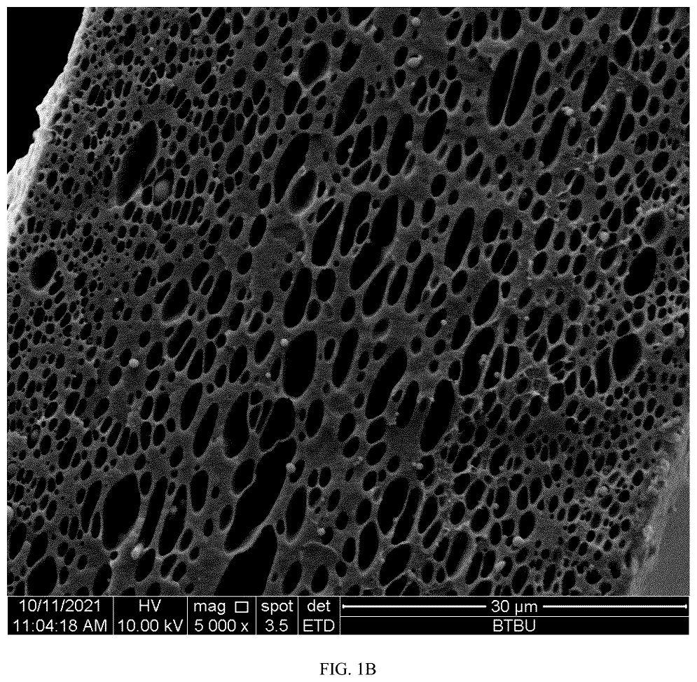

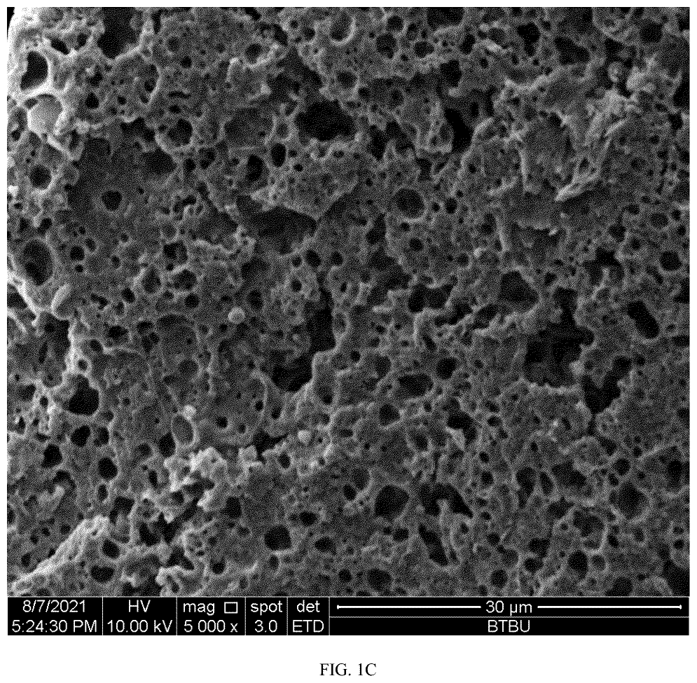

The packaging films prepared in Embodiment 3, Embodiment 8 and Comparative embodiment 3 are subjected to cross-sectional scanning electron microscope (SEM) scanning and the results are shown in FIG. 1A-FIG. 1C, where FIG. 1A is a cross-sectional SEM image of the packaging film prepared in Embodiment 3, FIG. 1B shows that of the packaging film prepared in Embodiment 8, and FIG. 1C shows that of the packaging film prepared in Comparative embodiment 3.

After the PBSA phase is etched with dichloromethane, the remaining phase is PGA and the pore structure remained is the dispersed state of the PBSA phase in PGA. Based on the cross-sectional SEM images, the PBSA of Embodiment 3 is in the form of elongated fibers, whereas the PBSAs of Embodiment 8 and Comparative embodiment 3 are in the form of granules, which further confirm that the lack of appropriate external traction in both the comparative embodiment 3 formed by press moulding and the Embodiment 8 formed by extrusion blowing with a low rate of stretching into a film results in the PBSA not being dispersed in fibrous form, but in granular form, thereby resulting in poor mechanical and barrier properties.

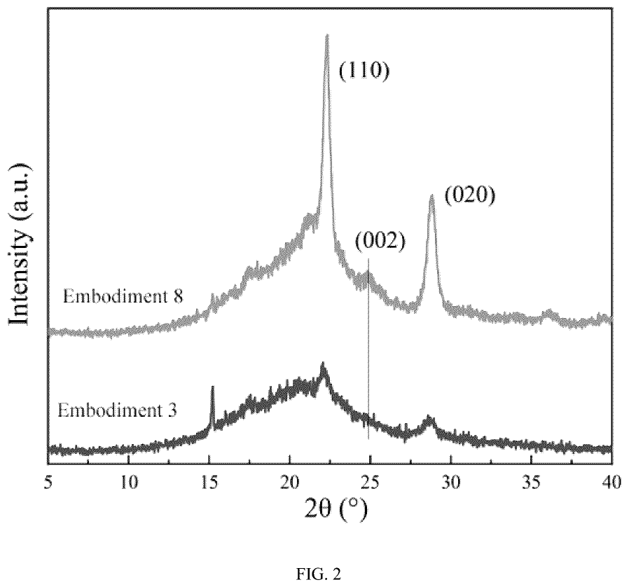

Further, the packaging films prepared in Embodiment 3 and Embodiment 8 are subjected to X-ray scanning and the results are shown in FIG. 2.

It can be seen from the X-ray diffraction pattern that the crystalline structures of Embodiment 3 and Embodiment 8 are different, where (002) crystalline planes are present in Embodiment 8 and (110) and (020) crystalline planes are significantly stronger than those in Embodiment 3; this is mainly attributed to the slow traction rate in Embodiment 8 and the crystals formed by the PGA are isotropic spherical crystals, whereas the synergistic effect of the stretching flow field and microfibers as heterogeneous nucleation sites in Embodiment 3 effectively promotes the movement of the PGA molecular chains to form a directionally aligned crystalline structure, and the (002) crystalline planes formed are along the normal direction and cannot be detected by the X-ray diffraction spectrum.

Accordingly, the high-barrier film obtained at a take-up speed of 1.5 m/min during the extrusion blowing process has excellent mechanical and barrier properties.

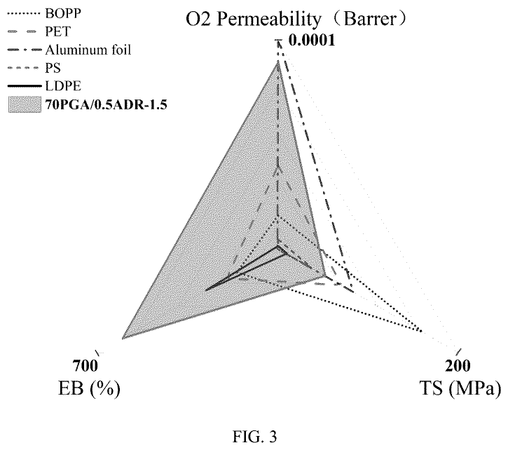

FIG. 3 shows a comprehensive comparison of the oxygen barrier properties, tensile strength and elongation at break of Embodiment 3 with the most commonly used commercially available high-barrier packaging films such as biaxially oriented polypropylene (BOPP), polyethylene terephthalate (PET), polystyrene (PS), low-density polyethylene (LDPE) and aluminum foil, where the corresponding area of Embodiment 3 of the present application is the largest, with the larger the corresponding area indicating better overall performance.

The above describes only the preferred specific embodiments of the present application, the scope of protection of the present application is not limited thereto, and any equivalent substitution or change made by any person skilled in the art in accordance with the technical schemes of the present application and its inventive concept within the technical scope disclosed herein shall be covered by the scope of protection of the present application.

1. A preparation method of a biodegradable high-barrier packaging film, including following steps: mixing polyglycolic acid (PGA), poly(butylene succinate-co-butylene adipate) (PBSA) and ADR 4468 (copolymer of styrene, acrylate and glycidyl acrylate), and performing melting, extruding and granulating to obtain a blends masterbatch; and then extrusion blowing the blends masterbatch into a film to obtain the biodegradable high-barrier packaging film;
wherein the biodegradable high-barrier packaging film comprises raw materials in parts by weight as follows: 60-70 parts of PGA, 30-40 parts of PBSA and 0.1-0.7 part of ADR 4468 (copolymer of styrene, acrylate and glycidyl acrylate), and a sum of the PGA and the PBSA is 100 parts; and
a temperature of extrusion blowing into the film is 215-220 degrees Celsius, and a take-up speed is 1.5 meters per minute.

2. The preparation method according to claim 1, wherein the biodegradable high-barrier packaging film comprises raw materials in parts by weight: 70 parts of PGA, 30 parts of PBSA and 0.5 part of ADR 4468 (copolymer of styrene, acrylate and glycidyl acrylate).

3. The preparation method according to claim 1, wherein the melting, extruding and granulating are carried out under a temperature of 180-230 degrees Celsius.

4. An application of the biodegradable high-barrier packaging film prepared by the preparation method according to claim 1 as food packaging materials.
